(19) United States
(12) Patent Application Publication
(10) Pub. No.: US 2003/0090563 A1
(43) Pub. Date: May 15, 2003

(54) Optical scanning device and image forming apparatus

(76) Inventors: Ken-ichi Tomita, Shizuoka (JP); Isshin Sato, Shizuoka (JP); Akihiro Fukutomi, Shizuoka (JP); Yasutaka Naruge, Shizuoka (JP)

Correspondence Address: FITZPATRICK CELLA HARPER & SCINTO, 30 ROCKEFELLER PLAZA, NEW YORK, NY, 10112, US

(21) Appl. No.: 10/283,059

(22) Filed: Oct. 30, 2002

(30) Foreign Application Priority Data
Oct. 30, 2001 (JP) 2001-333010 (PAT.

(51) Int. Cl. B41J 2/435

(52) U.S. Cl. 347/245

(57) ABSTRACT

An image forming apparatus have a light source, rotational polygon mirrors, reflecting mirrors, lenses. The polygon mirrors and said lenses are mounted on an optical box. The reference surface for mounting of the frame of the optical box on which the lenses are mounted is disposed in substantially parallel with the reference surface for mounting of it on which the polygon mirrors are mounted.

### BACKGROUND OF THE INVENTION

1. Field of the Invention

The present invention relates to an image forming apparatus such as a copying machine, a printer, and a facsimile, and more specifically, to an optical scanning device to be used therefore.

2. Description of the Related Art

Hitherto, in the optical scanning device to be used for a laser beam printer (LBP) or a digital copying machine, an image is recorded by deflecting a luminous flux modulated according to image signals and emitted by the light source periodically by an optical deflector including, for example, a rotational polygon mirror, converging it as a spot on an image bearing member (photosensitive drum) having a photosensitivity by a scanning lens having fθ characteristic (scanning lens), and optically scanning on the surface of the image bearing member.

FIG. 9 is a schematic drawing of the principal portion of an optical scanning device of this type in the related art.

In the optical scanning device shown in FIG. 9, a diverged luminous flux emitted from a light source 91 is transformed into a substantially parallel luminous flux by a collimator lens 92 and then enters into a cylinder lens (cylindrical lens) 94 for limiting the luminous flux (light quantity) by an aperture diaphragm 93 and having a predetermined refracting power only in the sub-scanning direction. The substantially parallel luminous flux entered into the cylinder lens 94 exits as is in the state of substantially parallel luminous flux in the main scanning section and converges in the sub-scanning section, so as to form an image on a deflection surface (reflection surface) 95a of an optical deflector 95 including a rotational polygon mirror as a substantial linear image.

Accordingly, the luminous flux deflected and reflected at the deflecting surface 95a of the optical deflector 95 is directed through the scanning lens having a fθ characteristic (fθ lens) 96 onto the surface of a photosensitive drum 98 as a scanned surface, and optically scans on the surface of the photosensitive drum 98 in the direction indicated by the arrow B by rotating the optical deflector 95 in the direction indicated by the arrow A. In such a procedure, an image is recorded on the surface of the photosensitive drum that corresponds to the image bearing member.

Recently, a color image forming apparatus including a plurality of (four for example) optical device for scanning is proposed (See JP-A-6-183056, JP-A-10-186254).

However, in such a color image forming apparatus in the related art as described above, the same number of optical scanning devices as the number of the photosensitive drums are required. Consequently, there arise problems that the proportion of the costs for the optical scanning devices in the image forming apparatus is high, and the image forming apparatus is obliged to be upsized.

In the case of optically scanning on the surface of the photosensitive drum using a reflection mirror, since the mounting surface of the optical box (not shown in the figure) for mounting the optical scanning element is molded with a slide core, the shape may be complexified and thus there is a room for improvement in the manufacturing process.

When the mounting surface of the optical box for mounting the optical scanning element is molded with a elide core, the positional displacement may arise with respect to the optical deflector mounted on the mounting surface of the optical box formed by a major metal mold and the optical scanning element, and thus there is a fear that it may influence on the quality of an image.

In addition, there is also a problem that the quality of a color image formed by superimposing the images may be deteriorated because mounting error of the respective optical scanning devices on the image forming apparatus and displacement of a plurality of scanning lines in association with variations in temperature may easily occur.

### SUMMARY OF THE INVENTION

Accordingly, it is an object of the present invention to enable production of a frame of the optical box having a reference surface for mounting on which a lens is mounted and a reference surface for mounting on which the deflecting unit is mounted with high degree of accuracy with a metal mold in a simple structure.

Further objects of the invention will become apparent from the following description.

### BRIEF DESCRIPTION OF THE DRAWINGS

In the accompanying drawings:

FIG. 1 is a drawing of a color image forming apparatus according to an embodiment of the invention;

FIG. 2 is a plan view of an optical scanning device according to the embodiment of the invention;

FIG. 3 is a cross sectional-view of the optical scanning device according to the embodiment of the invention;

FIG. 4 is an explanatory drawing illustrating adjustment of lateral magnification difference of the optical scanning device according to the invention;

FIGS. 5A and 5B are explanatory drawings illustrating adjustment of the height of the scanning lines in the optical scanning device according to the invention;

FIGS. 6A and 6B are explanatory drawings illustrating adjustment of inclination of the scanning lines in the optical scanning device according to the invention;

FIG. 7 is a partially enlarged drawing showing the mounting position for the second scanning lens on the frame according to the invention;

FIGS. 8A and 8B are drawings showing the positions of the gate and weld lines of the frame according to the invention; and

FIG. 9 is a drawing showing an optical scanning system in the related art.

### DETAILED DESCRIPTION OF THE PREFERRED EMBODIMENTS

Referring now to the drawings, a preferred embodiment of the invention will be described illustratively in detail.

However, the dimensions, material, configurations of the components, and the relative layout thereof stated in this embodiment are to be modified as needed depending on the construction of the apparatus to which the invention is applied, or on various conditions as needed, and are not intended to restrict the scope of the invention to the embodiment described below.

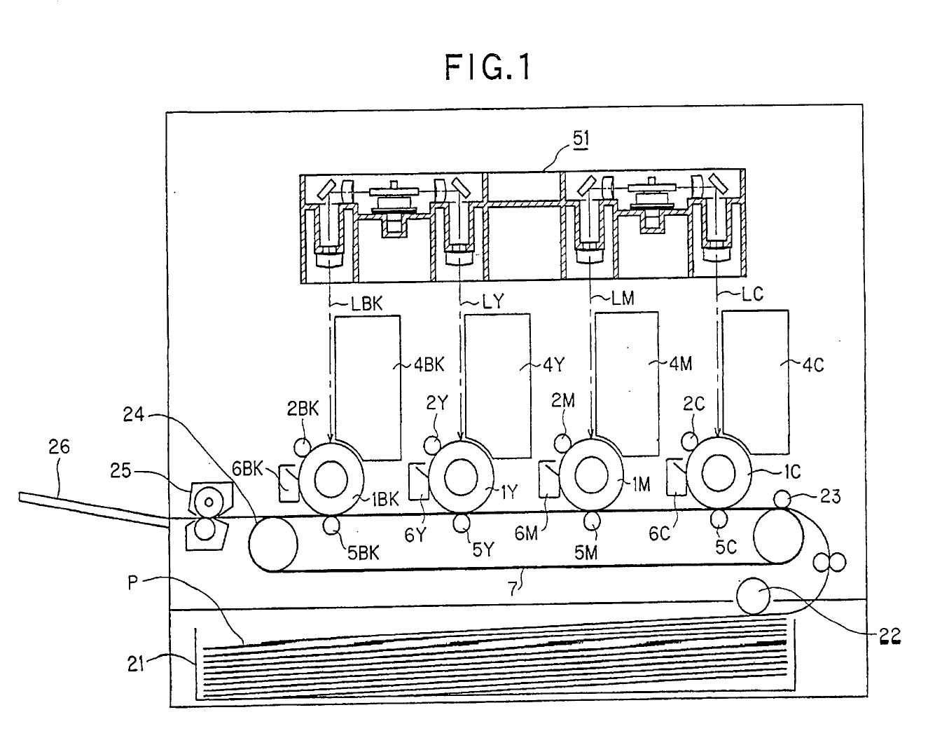

FIG. 1 is a schematic cross sectional view of the principal portion of a color image forming apparatus according to the invention. In the same figure, the reference numeral 51 denotes an optical scanning device having a construction that will be described later, the reference numerals and signs 1C, 1M, 1Y, 1BK denote image bearing members that correspond to photosensitive members, 2C, 2M, 2Y, 2BK denote primary chargers, 4C, 4M, 4Y, 4BK denote developing machines, 5C, 5M, 5Y, 5BK demote transfer rollers, and 6C, 6M, 6Y, 6BK denote cleaners.

The image bearing members 1C, 1M, 1Y, 1BK are uniformly charged by the primary chargers 2C, 2M, 2Y, 2BK, and the respective luminous flux (laser beam) LC, LM, LY, LBK modulated respectively based on image information form latent images on the corresponding image bearing members 1C, 1M, 1Y, 1BK. The respective latent images are visualized into images of cyan, magenta, yellow and black by the developing machines 4C, 4M, 4Y, 4BK respectively, and transferred in sequence by transfer rollers 5C, 5M, 5Y, 5BK on a transfer material P as a recording medium carried on a transfer belt 7 to form a color image. The residual toner remaining on the surfaces of the image bearing members 1C, 1M, 1Y, 1BK is removed by the cleaners 6C, 6M, 6Y, 6BK, and the image bearing members 1C, 1M, 1Y, 1BK are charged uniformly again by the primary chargers 2C, 2M, 2Y, 2BK respectively for forming the next color image.

The transfer material P is stacked in a paper feed cassette 21, and the transfer material P is fed one by one in sequence by a paper feed roller 22, and feed on the transfer belt 7 synchronizing with the timing to start transferring the image by a registration roller 23. A color image is formed on the transfer material P by transferring in sequence a cyan image, a magenta image, a yellow image, and a black image that are formed respectively on the image bearing members 1C, 1M, 1Y, 1BK while the transfer material P is carried on the transfer belt 7 with high degree of accuracy. A drive roller 24 feeds the transfer belt 7 accurately, and is connected to a drive motor, not shown, having little variation.

Accordingly, the color image formed on the transfer material P is heat-fixed by a fixer 25, and the transfer material P on which the color image is heat-fixed is output into a paper discharge tray 26.

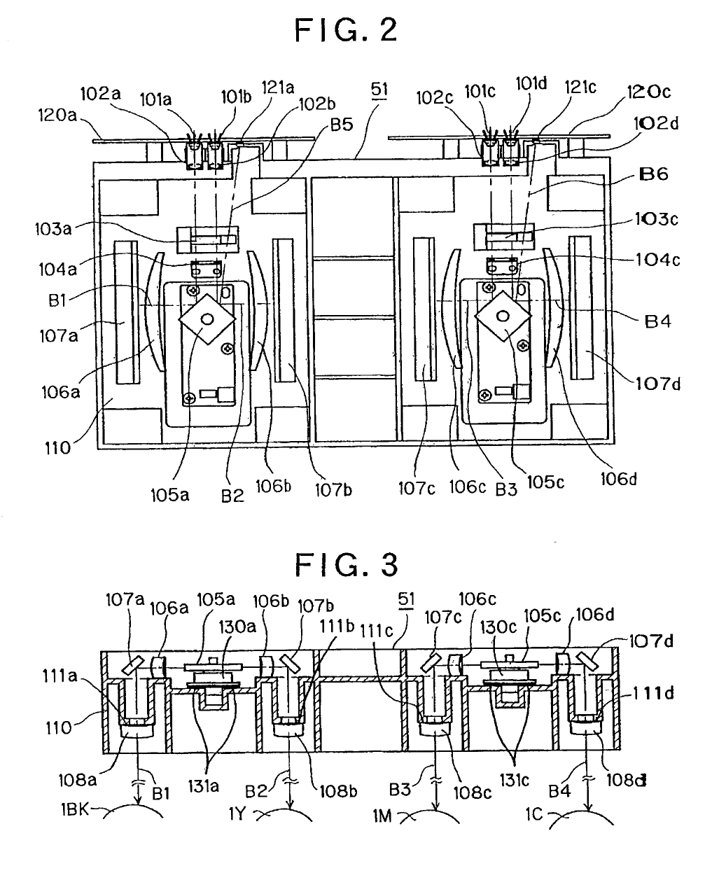

Referring now to FIG. 2 and FIG. 3, the construction of the optical scanning device 51 will be described. FIG. 2 is a plan view of the optical scanning device 51, and FIG. 3 is a cross sectional view of the same.

The optical scanning device 51 includes members required for irradiating four beams required for forming color images in different colors compactly accommodated in a single frame 110. These members will be described in detail below.

Beams (luminous flux) emitted from semiconductor lasers 101a, 101b, 101c, 101d as light sources pass respectively through collimator lenses 102a, 102b, 102c, 102d for transforming the respective beams into substantially parallel beams, then pass through cylindrical lenses 103a, 103c for converging the respective beams in the sub-scanning direction, and then a luminous flux off each beam is limited by aperture diaphragms 104a, 104c. The four beams passed through the aperture diaphragms 104a, 104c respectively enter into the different surfaces of the rotational polygon mirrors 105a, 105c constituting the deflection scanning unit, and are scanned in the different directions. At this time, the beams B5, B6 scanned by rotational polygon mirrors 105a, 105c enter into optical detectors 121a, 121c for generating synchronizing signals for aligning the position to start transferring the image in the main scanning direction. The optical detectors 121a, 121c are mounted on printed boards 120a, 120b having a driver IC including two each of semiconductor lasers 101a, 101b, 101c, 101d.

On the other hand, beam B1, B2, B3, B4 scanned by the rotational polygon mirrors 105a, 105c pass through the first scanning lenses 106a, 106b, 106c, 106d respectively, change the directions with the reflection mirrors 107a, 107b, 107c, 107d as reflecting members, pass through the second scanning lenses 108a, 108b, 108c, 108d, and form images by the scanning beam on the four image bearing members 1C, 1M, 1Y, 1BK as photosensitive members. At this time, the scanning beam may be irradiated at the desired positions on the four image bearing members 1C, 1M, 1Y, 1BK by adjusting the positions of the second scanning lenses 108a, 108b, 108c, 108d on the frame 110.

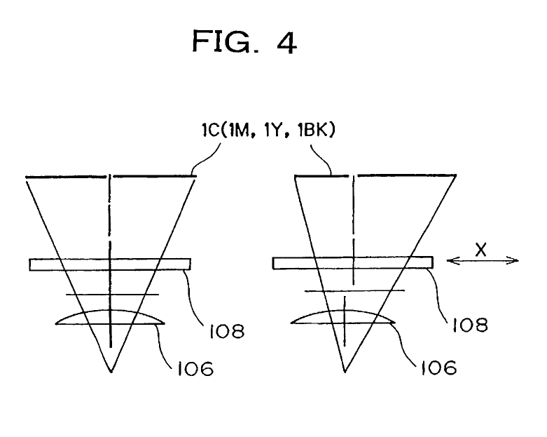

Referring now to FIG. 4 through FIG. 6, the position adjustment of the scanning beam in the optical scanning device of the invention will be described.

In FIG. 4, moving a second scanning lens 108 (any one of 108a, 108b, 108c, 108d) in the direction X allows adjustment of difference of length of the right and left parts of the scanning line with respect to the center of it in the main scanning direction on the image bearing member (it is hereinafter referred to by “lateral magnification”). In the optical scanning device of the invention, lateral magnification difference may be corrected by 20 μm by moving the scanning lens 108 in the direction X by about 0.05 mm. The amount of correction of lateral magnification difference is more or less proportionate to the amount of movement of the scanning lens 108, the lateral magnification difference may be adjusted by moving the scanning lens 108 in the direction X by the amount required for correction.

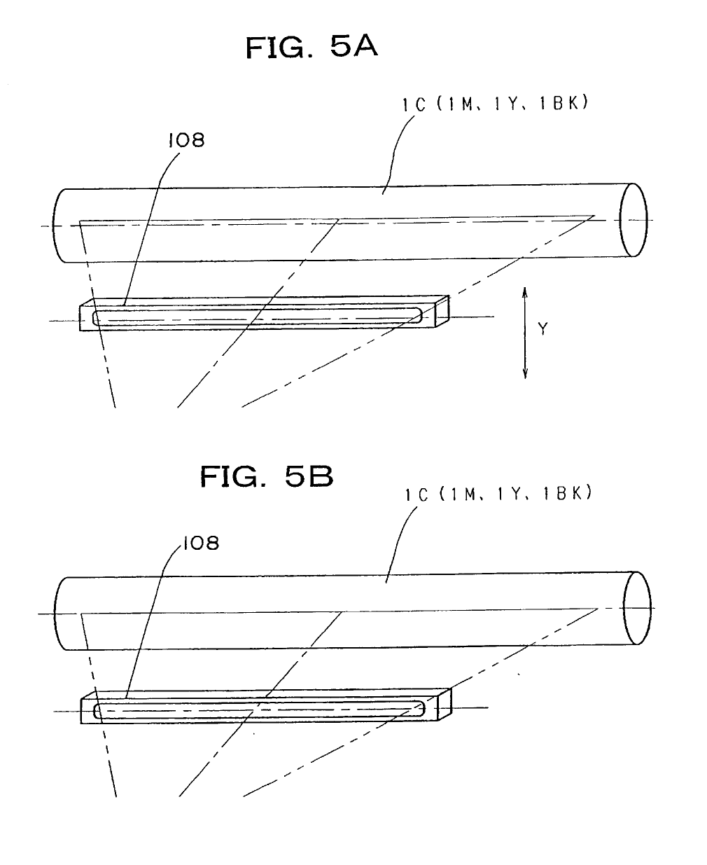

As shown in FIG. 5, by moving the second scanning lens 108 in the direction Y, the level of the scanning line on the image bearing member may be adjusted. In the optical scanning device of the invention, the level of the scanning line may be corrected by 0.12 mm by moving the scanning lens in the direction Y by approximately 0.05 mm. Since this amount of correction is more or less proportionate to the amount of movement of the scanning lens 108, the level of the scanning line may be adjusted by moving the scanning lens 108 in the direction Y by the amount required for correction.

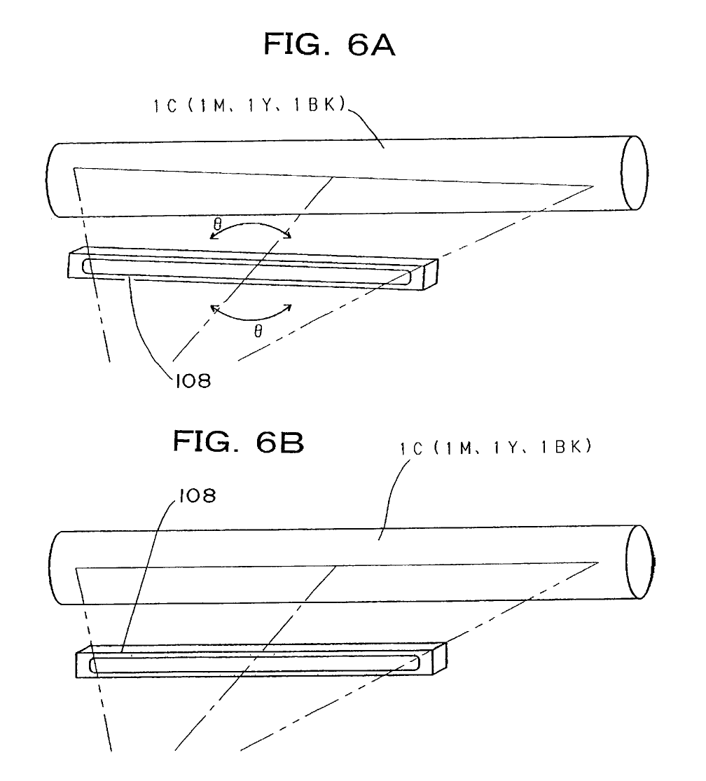

In addition, as shown in FIG. 6, the inclination of the scanning line on the image bearing member may be adjusted by moving the second scanning lens 108 in the direction θ. In the optical scanning device of the invention, inclination of the scanning line may be corrected by 0.2 mm by moving the scanning lens in the direction θ by approximately 3 minutes. Since this amount of correction is more or less proportionate to the amount of movement of the scanning lens 108, the inclination of the scanning line may be adjusted by moving the scanning lens 108 in the direction θ by the amount required for correction.

As is described above, the laser beam may be irradiated at the desired position on the respective image bearing members by adjusting the position of the second scanning lens.

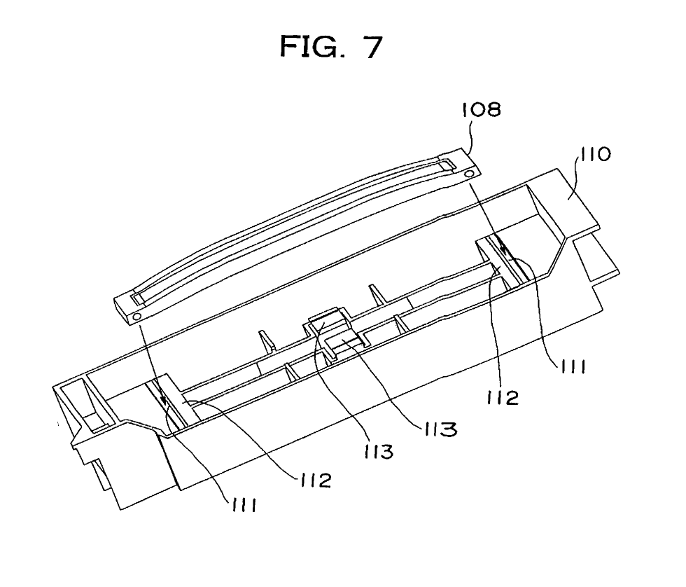

FIG. 7 shows a partially enlarged drawing showing around the fixed portion where the second scanning lens 108 is mounted on the frame. The frame 110 is provided with reference surfaces 111 to which the scanning lens 108 abuts at the position corresponding to both ends of the scanning lens 108, and bonding surfaces 112, 113 on which adhesive agent is applied. UV cure adhesive is applied on the bonding surfaces 112, 113 in advance, and the scanning lens 108 is securely brought into contact with the reference surfaces 111 by the use of a tool or the like. In this state, the scanning lens 108 is adjusted in the directions X, Y, and θ, and the position or the lateral magnification difference of the scanning beam are detected by the detector disposed at the position corresponding to the image bearing member. After having adjusted into a desired position, the UV light is irradiated to cure the adhesive and fix the scanning beam. By carrying out this procedure for four scanning lenses 108 (108a, 108b, 108c, 108d), the laser beam irradiated on the image bearing member has a uniform characteristic in terms of the position of irradiation or the lateral magnification difference.

Furthermore, as a characteristic of this embodiment, as shown in FIG. 3 and FIG. 7, the reference surfaces for mounting 111, the bonding surfaces 112, 113 for the second scanning lenses 108 (108a, 108b, 108c, 108d) on the frame 110 and the reference surfaces for mounting 131 the scanner motors 130 (130a, 130c) that constitute a deflection scanning unit are provided in substantially parallel with each other.

In this manner, since the direction of the parting surfaces (mold matching surfaces) when molding the frame 110 agree with each other by providing the reference mounting surfaces 111 for the second scanning lens 108 and the reference mounting surfaces 131 for the scanner motors 130 constituting the deflection scanning unit in parallel with each other, it is possible to form the reference mounting surfaces 111 or the bonding surfaces 112, 113 for the second scanning lens 108 without using a slide core for the mold of the frame, and thus improvement of mounting accuracy and reduction of the cost of the metal mold may be achieved.

Especially, the optical box constructed to scan the beam on the plurality of photosensitive drums with a single rotational polygonal mirror may be formed in the metal mold in a simple structure.

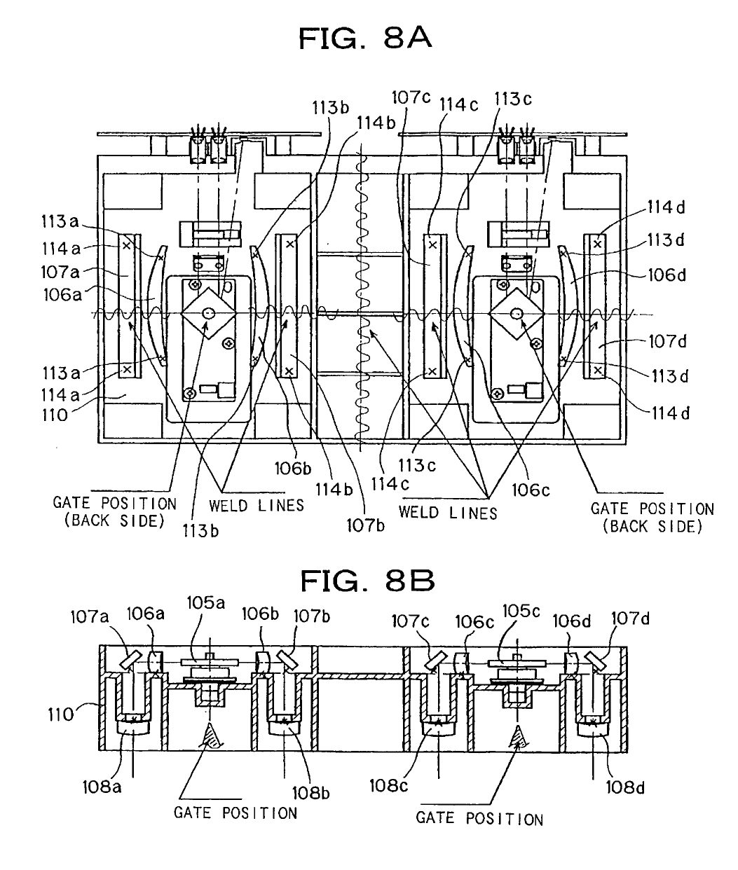

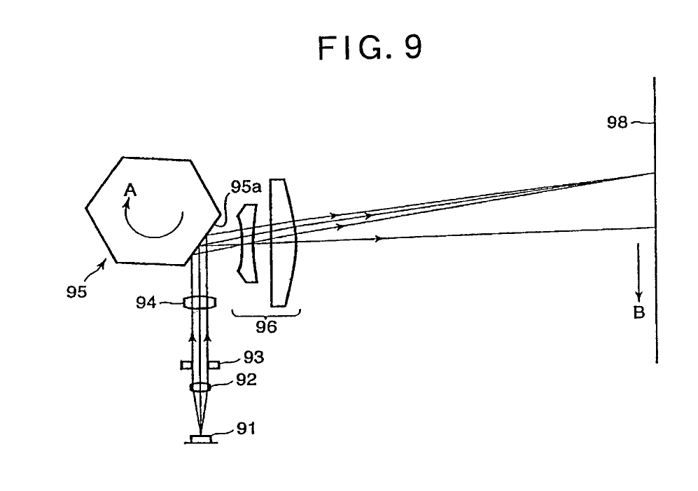

Further characteristic of the frame 110 of the invention is that there are two gates for filling plastic when molding as shown in FIG. 8. The gate is disposed at the position where the motor shaft of the deflection scanning unit is fitted, and is disposed on the backside when viewed from the direction of assembly. In other words, the gate is disposed on the frame 110 one for each set including two optical systems, and each gate is positioned substantially at the center between the symmetrical two optical systems of one set.

When molding the frame 110 with plastic with this gate position, the weld line generated on the frame 110 (a kind of molding defect generated at the point where melted materials are met during plastic molding) is generated at the position shown by the wave line. One is at the center of the two optical systems positioned at the equal distance from the two gate positions, and there is no member requiring accuracy at this position of the frame. Other weld lines are generated near the center of the first scanning lenses 106a, 106b, 106c, 106d, and near the center of the second scanning lenses 108a, 108b, 108c, 108d. However, since reference surfaces for mounting 113a, 113b, 113c, 113d of these scanning lenses and the reference surfaces 111 shown in FIG. 7 are disposed at both ends of the scanning lenses 106a, 106b, 106c, 106d and 108, they are kept clear of the weld line. In the same manner, since reference surfaces for mounting 114a, 114b, 114c, 114d are disposed at both ends for the reflecting mirrors 107a, 107b, 107c, 107d as well, they are kept away from the weld line. These reference surfaces for mounting are shown by “x” in FIG. 8.

In this manner, since each gate is disposed at substantially center of the two symmetrical optical systems on the frame, the position where the weld line is formed, which is otherwise difficult to estimate in the case of multiple gates method that includes a plurality of gates, may be estimated so that the reference surfaces for mounting the scanning lens and the reflection mirror can easily be disposed at the positions away from the weld line, whereby the accuracy may reliably be guaranteed. In addition, since variations in position of the optical parts are reduced, the quality of the image may be maintained at a high level.

When molding the frame 110 in a metal mold, the reference surfaces for mounting 111 of the second scanning lens 108 and the reference surface for mounting 131 on which the deflection scanning unit is mounted may be formed in the same metal mold.

Though the case in which the semiconductor laser having one light-emitting point is used as light source has been described in this embodiment, the same effects may be achieved even when the semiconductor laser having a plurality of light-emitting points such as a multi-beam laser are used.

As is described thus far, according to the invention, since the directions of the reference surfaces for mounting of the optical box on which the optical members are mounted, that of the reference surface for mounting of the optical box on which the deflection scanning unit is mounted, and that of the parting surface of the optical box are agreed with each other, the reference surface for mounting of the optical box on which the optical member is mounted may be formed without using the slide care on the mold for molding the optical box. Therefore, the optical box may be formed in the mold in a simple structure.

Since the number of the rotational polygon mirrors, the optical deflectors, and the optical boxes may be reduced with the construction in which the beam is scanned on a plurality of photosensitive drums with a single rotational polygon mirror. In addition, the costs for the mold for molding the optical box that constitutes the frame may be reduced, whereby the construction of the optical scanning device may be simplified, thereby reducing the costs.

Furthermore, the mounting accuracy of the optical components is improved, and thus the quality of the image may be improved.

What is claimed is:

1. An optical scanning device comprising:
a light source;
a deflection scanning unit for deflecting and scanning a beam emitted from said light source;
a reflecting member for reflecting a beam that is deflected and scanned by said deflection scanning unit;
a lens through which a beam reflected from said reflecting member passes; and
a frame on which at least said deflection scanning unit and said lens are mounted;
wherein the reference surface for mounting of the frame on which said lens is mounted is disposed in substantially parallel with the reference surface for mounting of the frame on which said deflection scanning unit is mounted.

2. An optical scanning device according to claim 1, wherein said frame is molded, and said reference surface for mounting of the frame on which said lens is mounted and said reference surface for mounting of the frame on which said deflection scanning unit is mounted are formed in the same metal mold.

3. An optical scanning device according to claim 1, wherein said deflection scanning unit have a rotational polygon mirror, and said one rotational polygon mirror deflects and scans a plurality of beams.

4. An optical scanning device according to claim 3, wherein there are provided a plurality of said reflecting members and said lenses respectively, and said reflecting members and said lenses are respectively provided for each of said plurality of beams that are deflected and scanned by said rotational polygon mirror.

5. An optical scanning device according to claim 4, wherein said lens is a scanning lens disposed at the position closest to a photosensitive member.

6. An optical scanning device according to claim 1, wherein said frame is molded of plastic, and comprises a gate position through which plastic is filled for molding, and said gate is positioned in the vicinity of the center of rotation of said deflection scanning unit.

7. An optical scanning device according to claim 3, wherein said deflection scanning unit comprises two rotational polygon mirrors, each of said rotational polygon mirror deflects two beams, and said reflecting members and said lenses are respectively provided for each of four deflected beams.

8. An optical scanning device according to claim 7, wherein two each of said reflecting members and said leases are disposed substantially symmetrical with respect to said single rotational polygon mirror.

9. An optical scanning device according to claim 8, wherein said frame is molded of plastic, and comprises gate positions through which plastic is filled for molding, and said gate positions are respectively provided in the vicinities of the centers of rotation of said two rotational polygon mirrors.

10. An optical scanning device according to claim 1, wherein said light source comprises a plurality of semiconductor lasers disposed on a common printed board, and laser beams emitted from said semiconductor lasers are deflected respectively in the symmetrical directions with respect to the axis of rotation of said deflection scanning unit.

11. An optical scanning device according to claim 10, further comprising an light detector for detecting beam deflected and scanned by said deflection scanning unit, wherein said light detector is disposed on said printed board.

12. An optical scanning device comprising:
a light source;
a deflection scanning unit for deflecting and scanning a beam emitted from said light source;
a reflecting member for reflecting a beam that is deflected and scanned by said deflection scanning unit;
a lens through which a beam reflected from said reflecting member passes; and
a frame on which said lens is mounted;
wherein the reference surface for mounting of the frame on which said lens is mounted is disposed in substantially orthogonal to the beam reflected from said reflecting member.

13. An optical scanning device according to claim 12, wherein said lens is movable and adjustable in the state of being abutted to the reference surface for mounting of the frame on which said lens is mounted.

14. An image forming apparatus comprising:
a light source;
a deflection scanning unit for deflecting and scanning a beam emitted from said light source;
a reflecting member for reflecting a beam that is deflected and scanned by said deflection scanning unit;
a lens through which a beam reflected from said reflecting member passes;
a photosensitive member on which a beam passed through said lens is irradiated;
a frame on which at least said deflection scanning unit and said lens are mounted;
wherein the reference surface for mounting of the frame on which said lens is mounted is disposed in substantially parallel with the reference surface for mounting of the frame on which said deflection scanning unit is mounted.

15. An image forming apparatus according to claim 14, wherein said deflection scanning unit have a rotational polygon mirror, and said one rotational polygon mirror deflects and scans a plurality of beams.

16. An image forming apparatus according to claim 15, wherein there are provided a plurality of said reflecting members and said lenses respectively, and said reflecting members and said lenses are respectively provided for each of said plurality of beams that are deflected and scanned by said rotational polygon mirror.

17. An image forming apparatus according to claim 16, wherein said lens is a scanning lens disposed at the position closest to said photosensitive member.

18. An image forming apparatus according to claim 14, wherein said frame is molded of plastic, and comprises a gate position through which plastic is filled for molding, and said gate position is positioned in the vicinity of the center of rotation of said deflection scanning unit.

19. An image forming apparatus according to claim 15, wherein said deflection scan unit comprises two rotational polygon mirrors, each of said rotational polygon mirror deflects two beams, said reflecting members and said lenses are respectively provided for each of four deflected beams.

20. An image forming apparatus according to claim 19, wherein two each of said reflecting members and said lenses are disposed substantially symmetrical with respect to said single rotational polygon mirror.

21. An image forming apparatus according to claim 20, wherein said frame is molded of plastic, and comprises gate positions through which plastic is filled for molding, and said gate positions are respectively provided in the vicinities of the centers of rotation of said two rotational polygon mirrors.

22. An image forming apparatus according to claim 14, wherein said light source comprises a plurality of semiconductor lasers disposed on a common printed board, and laser beams emitted from said semiconductor lasers are deflected respectively in the symmetrical directions with respect to the axis of rotation of said deflection scanning unit.

23. An image forming apparatus according to claim 22, further comprising an light detector for detecting beam deflected and scanned by said deflection scanning unit, wherein said light detector is disposed on said printed board.

24. An image forming apparatus according to claim 14, wherein said frame is molded, and said reference surface for mounting of the frame on which said lens is mounted and said reference surface for mounting of the frame on which said deflection scanning unit is mounted are formed in the same metal mold.
